(19) United States
(12) Patent Application Publication
(10) Pub. No.: US 2012/0166439 A1
(43) Pub. Date: Jun. 28, 2012

(54) METHOD AND SYSTEM FOR CLASSIFYING WEB SITES USING QUERY-BASED WEB SITE MODELS

(75) Inventors: Barbara Poblete, Santiago (CL); Maria Spiliopoulou, Berlin (DE); Marcelo Mendoza, Santiago (CL)

(73) Assignee: YAHOO! INC., Sunnyvale, CA (US)

(21) Appl. No.: 12/979,792

(22) Filed: Dec. 28, 2010

(51) Int. Cl. G06F 17/30

(52) U.S. Cl. 707/737; 707/E17.046

(57) ABSTRACT

Web sites are grouped by generating feature space representations of documents, and aggregating the feature space representations into web site vectors. A document vector may be generated for each document of a plurality of documents associated with a set of web sites according to a query-based feature space model. The query-based feature space model defines features of the documents. Each document vector includes weights determined for features associated with the corresponding document. A web site vector is generated for each of the web sites using the plurality of document vectors. The web sites are grouped according to the web site vectors.

### BACKGROUND OF THE INVENTION

1. Field of the Invention

The present invention relates to the classifying and clustering of web sites.

2. Background

Information retrieval (IR) is the science of searching for documents, for information within documents, and for metadata about documents, as well as that of searching relational databases and the World Wide Web. With regard to the World Wide Web, information retrieval may be referred to as web information retrieval (WIR). Traditionally, WIR relates to the retrieval of web documents that satisfy a particular text query. The enormous growth of the web has made it increasingly important to find ways to extend WIR towards richer functionalities.

To facilitate WIR, it is desired to organize web documents that are similar. For example, techniques of clustering and classification may be used to organize web documents. Many current web document clustering and classification techniques are based on the contents of documents and rely on vector-space document models that represent documents as vectors of terms in the documents. Implicit user feedback, such as clicked answers for queries submitted to search engines, has been used to classify web documents. There have also been efforts towards the automatic classification of web sites (also referred to as “websites”). Current approaches to classifying web sites include modeling web sites as feature vectors, where the vectors include term-based feature spaces (based on terms in the documents of the web sites) or topic-based feature spaces. However, these techniques often require extensive preprocessing or background knowledge of the web site domains being analyzed, among other problems.

### BRIEF SUMMARY OF THE INVENTION

Various approaches are described herein for, among other things, grouping web sites. For instance, various approaches are described herein for generating representations of web sites (e.g., web site vectors) based on queries submitted to search on documents of the web sites. Query related information may be used in various ways to define a feature space for generating representations of the documents of the web sites, and the document representations may be combined to generate the web site representations. The generated web site representations may be used to group the web sites, such as by using techniques of classifying or clustering.

In one method implementation, web sites are grouped by generating feature space representations of documents, and aggregating the feature space representations into web site vectors. For instance, a plurality of documents associated with a plurality of web sites is received. A document vector is generated for each of the plurality of documents according to a query-based feature space model to generate a plurality of document vectors. The query-based feature space model defines features of the documents. Each document vector includes weights determined for features associated with the corresponding document. A web site vector is generated for each of the web sites using the plurality of document vectors. The web sites are grouped according to the web site vectors.

Various query-based feature spaces models may be used to define a feature space for generating the document vectors. In one approach, a query-terms feature space model may be used that defines individual query-terms of the queries as the features. Each document vector may be generated to include a weight for each query-term included in at least one query that resulted in the corresponding document being selected.

In another approach, a full-queries feature space model may be used that defines the queries as the features. Each document vector may be generated to include a weight for each query that resulted in the corresponding document being selected.

In another approach, a full patterns feature space model may be used that defines sets of query-terms in queries as the features. Each document vector may be generated to include a weight for each set of query-terms that was included in a query that resulted in the corresponding document being selected.

In another approach, a maximal patterns feature space model may be used that defines maximal length sets of query-terms in queries as the features. Each document vector may be generated to include a weight for each maximal length set of query-terms that was included in a query that resulted in the corresponding document being selected.

In still another approach, a full-queries plus feature space model may be used that defines sets of query-terms that match full-queries in the log of queries as the features. Each document vector may be generated to include a weight for each set of query-terms matching a full query in the log of queries that resulted in the corresponding document being selected.

In one implementation, a system for enabling web sites to be grouped is provided. The system includes a document vector generator, a web site vector generator, and a web site grouper. The document vector generator receives a plurality of documents associated with a plurality of web sites. The document vector generator generates a document vector for each of the plurality of documents according to a query-based feature space model. The web site vector generator generates a web site vector for each of the web sites using the generated document vectors. The web site grouper groups the web sites according to the web site vectors.

Computer program products are also described herein. The computer program products include a computer-readable medium having computer program logic recorded thereon for grouping web sites, and for enabling further embodiments, according to the implementations described throughout this document.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of an example search network, according to an embodiment.

FIG. 2 shows an example query that may be submitted by a user to a search engine.

FIG. 3 shows a block diagram of a search system, according to an example embodiment.

FIG. 4A shows a block diagram of a web site classification module, according to an example embodiment.

FIG. 4B shows a block diagram of a web site representation generator, according to an example embodiment.

FIG. 4C shows a block diagram of a document vector generator, according to various example embodiments.

FIG. 4D shows a block diagram of a web site grouper, according to an example embodiment.

FIG. 5 is a schematic diagram showing a web site cluster, according to an example embodiment.

FIG. 6A shows a flowchart for classifying a web site, according to an example embodiment.

FIG. 6B shows a flowchart for using a feature space model to generate document vectors, according to an example embodiment.

FIG. 7 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is assumed that it is within the knowledge of one skilled in the art to implement such feature, structure, or characteristic in connection with other embodiments whether or not explicitly described.

Example embodiments are described in the following sections. It is noted that the section/subsection headings provided herein are not intended to be limiting. Embodiments are described throughout this document, and any type of embodiment may be included in any section/subsection.

### II. Example Embodiments for Determining Representations for Web Sites and for Grouping Web Sites

Embodiments of the present invention enable grouping of web sites using modeling techniques that are query-based. Compact representations of web sites are generated based on queries applied to the web sites. For example, vectors for the web sites may be generated based on the queries. In an embodiment, a vector-space model traditionally used for individual documents is expanded to apply to entire web sites (or other document groupings) to generate the web site vectors. Document vector representations generated for the documents of the web site may be combined into a vector that represents the entire web site. Web sites may be grouped based on the generated web site vectors. Such embodiments have advantages over traditional techniques, which model web sites based on the contents of the documents of the web site (e.g., based on terms in the documents).

Embodiments described herein enable relevant web sites located in the World Wide Web to be classified and/or clustered based on their relevance and utility, according to the needs and interests of users. The approaches utilize a framework for representing web sites over different query-based feature selection schemes, providing more compact representations of web sites and desirable trade-offs between performance and quality/dimensionality of applied techniques.

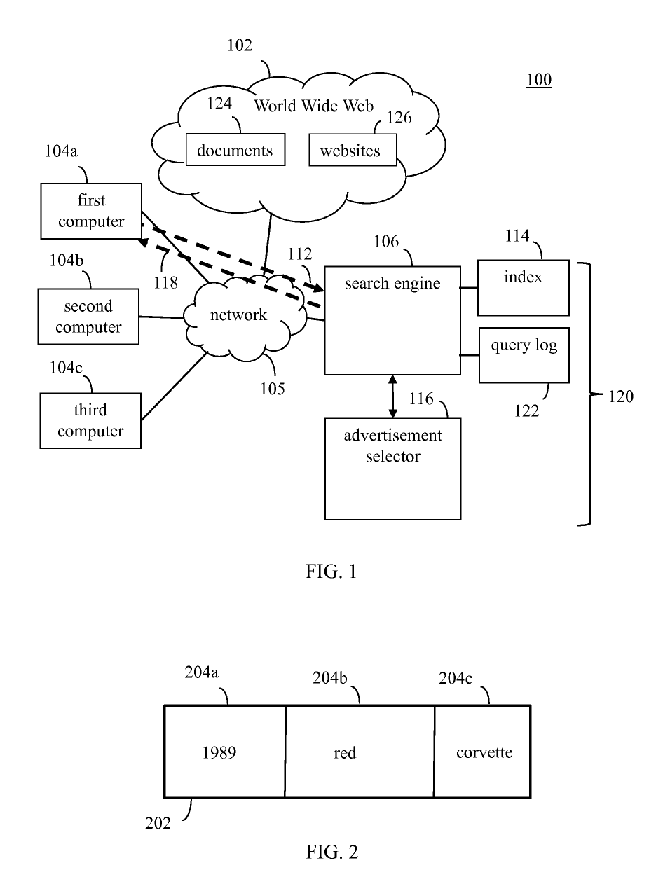

Embodiments for generating web site representations, and for grouping web sites, may be implemented in a variety of environments, including online and offline search environments, information retrieval environments, site classification environments, and so on. For instance, FIG. 1 shows a search network 100, which is an example environment in which web site representations may be generated, and grouping of web sites may be performed. As shown in FIG. 1, network 100 includes a search system 120. Search system 120 is configured to provide search results for a received search query 112, to provide matching advertisements, and to store search related information in databases. As shown in FIG. 1, search system 120 includes a search engine 106, advertisement selector 116, and query log 122. These and further elements of network 100 are described as follows to illustrate an example search network in which embodiments may be implemented. It is noted that embodiments may also be implemented in other environments.

As shown in FIG. 1, one or more computers 104, such as first-third computers 104a-104c, are connected to a communication network 105. Network 105 may be any type of communication network, such as a local area network (LAN), a wide area network (WAN), or a combination of communication networks. In embodiments, network 105 may include the Internet and/or an intranet. Computers 104 can retrieve documents from entities over network 105. Computers 104 may each be any type of suitable electronic device, typically having a display and having web browsing capability, such as a desktop computer (e.g., a personal computer, etc.), a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), or a mobile email device. In embodiments where network 105 includes the Internet, numerous web sites and documents, including documents 124 and web sites 126 (that each include one or more documents of documents 124) that form a portion of World Wide Web 102, are available for retrieval by computers 104 through network 105. On the Internet, documents may be identified/located by a uniform resource locator (URL), such as http://www.documents.com/documentX, and/or by other mechanisms. Computers 104 can access documents 124 and web sites 126 through network 105 by supplying a URL corresponding to documents 124 and web sites 126 to a document server (not shown in FIG. 1).

As shown in FIG. 1, search engine 106 is coupled to network 105. Search engine 106 accesses a stored index 114 that indexes documents, such as documents of World Wide Web 102. A user of computer 104a who desires to retrieve one or more documents relevant to a particular topic, but does not know the identifier/location of such a document, may submit a query 112 to search engine 106 through network 105. For instance, the user may enter query 112 into a search engine entry box displayed by computer 104a (e.g., by a web browser). Search engine 106 receives query 112, and analyzes index 114 to find documents and web sites relevant to query 112. For example, search engine 106 may determine a set of documents indexed by index 114 that include terms of query 112. The set of documents may include any number of documents, including tens, hundreds, thousands, or even millions of documents. Search engine 106 may use a ranking or relevance function to rank documents of the retrieved set of documents in an order of relevance to the user. Documents and web sites of the set determined to most likely be relevant may be provided at the top of a list of the returned documents in an attempt to avoid the user having to parse through the entire set of documents.

Search engine 106 stores search related information in a query log 122 or other similar database. Query log 122 contains and stores information associated with query 112 and other queries received at search engine 106. For instance, after performing searches for received queries, search engine 106 may store the contents of queries (e.g., the query-terms), may indicate one or more of documents 124 returned in response to queries, and may indicate one or more of documents 124 that were selected or clicked in response to queries. That is, query log 122 may store one or more data structures that relate queries received at search engine 106 to one or more of documents 124 returned as results of queries, and that may ultimately have been selected by users that submitted the queries.

Search engine 106 may be implemented in hardware, software, firmware, or any combination thereof. For example, search engine 106 may include software/firmware that executes in one or more processors of one or more computer systems, such as one or more servers. Examples of search engine 106 that may be accessible through network 105 include, but are not limited to, Yahoo! Search™ (at http://www.yahoo.com), Microsoft Bing™ (at www.bing.com), Ask.com™ (at http://www.ask.com), and Google™ (at http://www.google.com).

FIG. 2 shows an example search query 202 that may be submitted by a user of one of computers 104a-104c of FIG. 1 to search engine 106. Query 202 is an example of query 112, and includes one or more terms or features 204, such as first, second, and third features 204a-204c shown in FIG. 2. Any number of features 204 may be present in a query. As shown in FIG. 2, features 204a-204c of query 112 are “1989,” “red,” and “corvette.” Search engine 106 applies these features 204a-204c to index 114 to retrieve a document locator, such as a URL, for one or more indexed documents that match 1989″, “red”, and “corvette”, and may order the list of documents according to a ranking. The list of documents may be displayed to the user in response to query 202.

Often, web site owners and authors desire to be seen by many users, and attempt to facilitate being found by optimizing their presence to search engines. Likewise, search engines wish to present the most relevant web sites to users in response to received search queries. Classification and clustering techniques facilitate grouping of web sites to one another and to certain topics or concepts, enabling search engines to retrieve and provide relevant web sites to users submitting search queries, even when the search queries are not necessarily or directly related to retrieved web site (i.e., a retrieved web site may not contain any terms of a submitted query, but still be deemed relevant to the query based on its similarity to web sites in the same cluster or class).

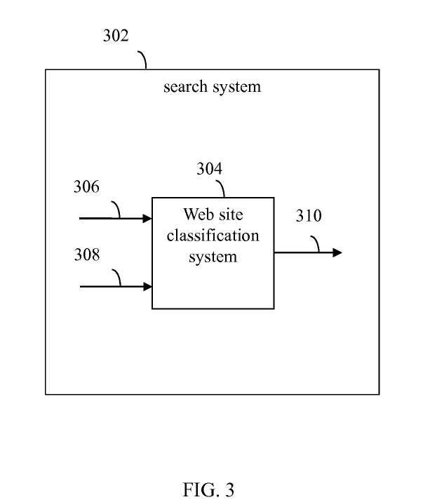

Embodiments of the present invention provide approaches that generate representations for web sites based on query-based information, and that group the web sites based on the generated representations. For instance, FIG. 3 shows a block diagram of a search system 302, according to an example embodiment. Similarly to search system 120 of FIG. 1, search system 302 may include a search engine (e.g., search engine 106) and associated query log (e.g., query log 122). Furthermore, as shown in FIG. 3, search system 302 includes a web site classification system 304. Web site classification system 304 receives documents 306 and query information 308. For example, query information 308 may be a log of query information, such as a query log(e.g., 122 of FIG. 1), that indicates queries received by a search engine, the documents indicated in the results for each query, and an indication of which documents were selected (e.g., “clicked”) in the results for each query. Documents 306 include a subset of documents 124 available in the World Wide Web 102. For example, documents 306 may include the documents that are indicated in query information 308 as appearing in query search results and/or having been selected. Web site classification system 304 is configured to generate groups of web sites (e.g., groupings of some or all of web sites 126 available in World Wide Web 102) based on documents 306 and query information 308, indicating the generated groups in grouping information 310.

Although web site classification system 304 is shown in FIG. 3 as being included in search system 302, in other embodiments, web site classification system 304 may be located elsewhere other than in a search system.

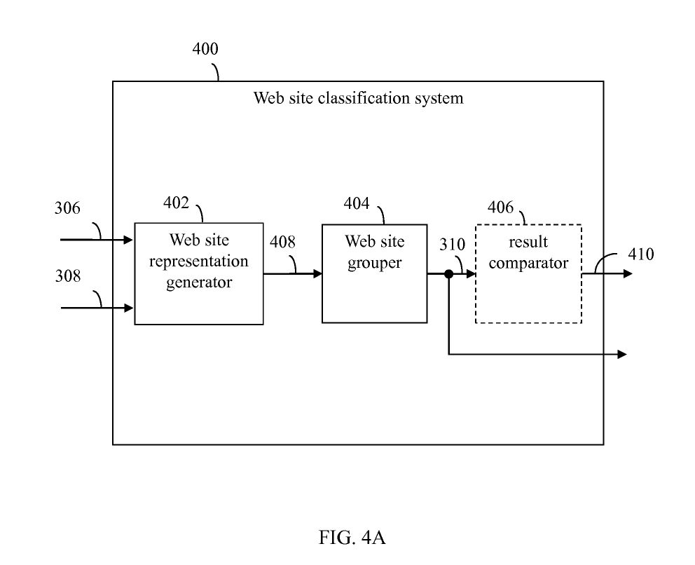

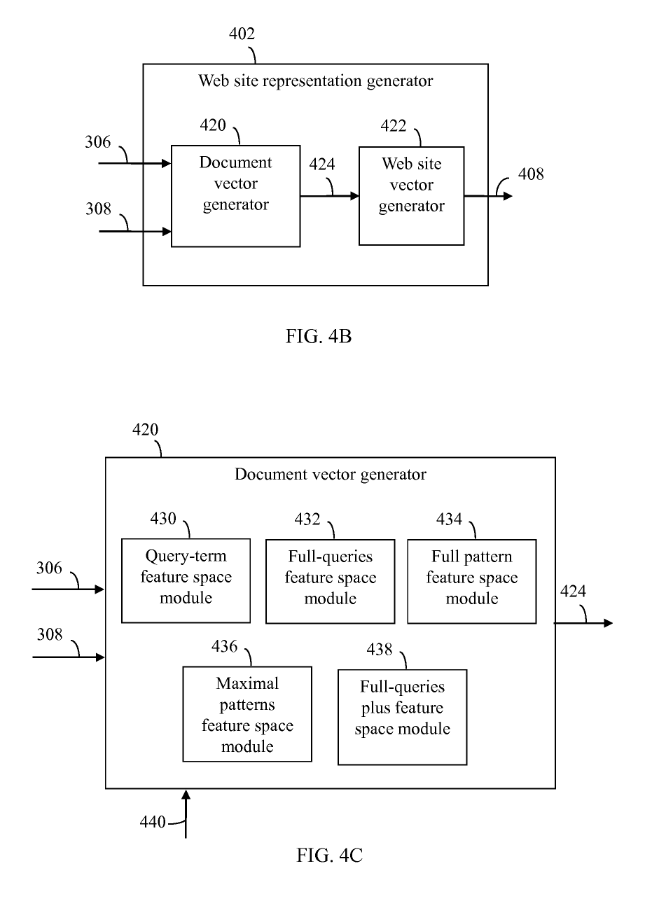

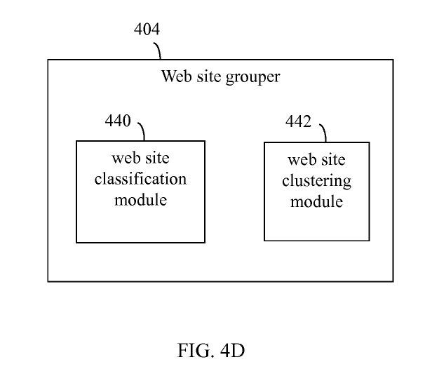

Web site classification system 304 may be configured in various ways, in embodiments. For instance, FIG. 4A shows a block diagram of web site classification system 400, according to an example embodiment. Web site classification system 400 is an example of web site classification system 304 of FIG. 3. As shown in FIG. 4A, web site classification system 400 includes a web site representation generator 402, a web site grouper 404, and a result comparator 406. Result comparator 406 is optionally present. These elements of web site classification system 400 are described as follows.

As shown in FIG. 4A, web site representation generator 402 receives documents 306 and query information 308. As described above, documents 306 may include documents that are indicated in query information 308 as appearing in search results for queries and/or were listed in search results and selected by a user. Any number of documents may be included in documents 306, including tens, hundreds, thousands, tens of thousands, millions, and even greater numbers of documents. Documents 306 may include the full text of all of documents 306, or may include portions thereof (e.g., keywords of documents, etc.).

In embodiments, web site representation generator 402 is configured to determine and/or generate representations for a plurality of web sites based on documents 306 and query information 308. For example, web site representation generator 402 may generate web site representations in the form of vectors, or in other forms. For the purposes of modeling web sites in the form of vectors, a web site may generally be considered to be a collection of documents that cover a broad topic (e.g., “cars”), although a web site may also be a collection of documents that cover one specific topic (e.g., “hybrid engines”). In embodiments, a web site is considered to be all of the documents of documents 306 that are contained under a same host name. As such, documents 306 may include any number of web sites that include documents of documents 306, including tens, hundreds, thousands, and even greater number of web sites. Web site representation generator 402 may receive or store (e.g., in storage) a data structure (e.g., a list, array, table, etc.) that indicates a plurality of web sites, and indicates the documents included in each web site. During a particular iteration of web site representation generator 402, one or more of the web sites may be designated for grouping (e.g., by a user that interacts with a user interface associated with web site classification system 400, etc.). As shown in FIG. 4A, web site representation generator 402 outputs web site vectors 408, which includes the web site vectors generated for the web sites designated for grouping. Note that in different embodiments, web site representation generator 402 may generate web site vectors 408 in different ways, based on a particular feature space defined for documents 306. Examples of such features spaces are described in further detail below.

Web site grouper 404 receives web site vectors 408. Web site grouper 404 is configured to group the web sites of web site vectors 408. Web site grouper 404 may use one or more grouping techniques, including techniques known to persons skilled in the relevant art(s). For instance, in some embodiments, web site grouper 404 may use classification techniques and/or clustering techniques to form groups of web sites according to the received web site vectors. As shown in FIG. 4A, web site grouper 404 generates grouping information 310.

Result comparator 406 is optionally present. When present, result comparator 406 may receive grouping information 310 generated for different sets of web site vectors 408 generated by web site representation generator 402 based on different feature spaces. Result comparator 406 may compare grouping information 310 generated for the different sets of web site vectors 408 to determine the relative performance for the different feature spaces, as some feature space definitions may enable better grouping of web sites than some other feature space definitions. As shown in FIG. 4A, result comparator 406 generates comparison results 410, which indicates performance information for the feature space definitions.

Example embodiments are described in the following subsections for web site classification. For example, a next subsection describes example embodiments for web site representation generator 402, followed by a subsection that describes example embodiments for web site grouper 404, followed by a subsection that describes example embodiments for result comparator 406, followed by a subsection that describes example processes for representing and grouping web sites.

A. Example Embodiments for Generating Representations for Web Sites

Web site representation generator 402 may be configured in various ways to generate representations of web sites (e.g., web site vectors 408), in embodiments. For instance, FIG. 4B shows a block diagram of web site representation generator 402, according to an example embodiment. As shown in FIG. 4B, web site representation generator 402 includes a document vector generator 420 and a web site vector generator 422. These features of web site representation generator 402 are described as follows.

As shown in FIG. 4B, document vector generator 420 receives documents 306 and query information 308. Document vector generator 420 generates a document vector for each document of documents 306 according to a query-based feature space model. The query-based feature space model defines features of documents 306. Each document vector generated by document vector generator 420 includes weights determined for features associated with the corresponding document. As shown in FIG. 4B, document vector generator 420 generates a plurality of document vectors 424, which includes the document vectors generated for each of documents 306.

Web site vector generator 422 receives document vectors 424. Web site vector generator 422 generates a web site vector for each of the web sites designated for grouping using document vectors 424. For example, in an embodiment, web site vector generator 422 may sum document vectors of document vectors 424 for the documents that constitute a particular web site to generate a web site vector corresponding to the web site. Each web site vector may be generated in this manner. As shown in FIG. 4B, web site vector generator 422 generates a plurality of web site vectors 408, which includes the web site vectors generated for each of the web sites.

Examples of document vector generation by document vector generator 420, and of web site vector generation by web site vector generator 422, are described further as follows.

For example, D={d1, d2, . . . , dn} may represent the collection of “n” documents “d” included in documents 306. F={f1, f2, . . . , fm} represent a set of “m” features “f” (a “feature space”) that characterize the documents in D. The feature space F is generalized according to a vector space model such that features “f” may be any features associated with a document D, including query-based features (e.g., queries, query-terms, query-sets, etc.). “wi,j” may be a weight associated with the document-feature pair (di, fj). A generic document vector for document di is defined as di=<wi,1, wi,2, . . . , wi,j, . . . , wi,m>, which includes weights associated with the features of the set of features F. The generic document vector is a generalization of a vector space document model (e.g., the “bag-of-words” model), which incorporates an m-dimensional feature space F. In such a vector-space representation, feature space F corresponds to the set of terms in the documents of D, and weight wi,j corresponds to the weight of the jth-term in the ith-document. For instance, in an embodiment, weight wi,j may corresponds to the weight of the jth-term in the ith-document according to the term frequency (the number of times that the term appears) in document di.

As such, document vector generator 420 may generate document vectors 424 to include documents vectors in the form of a vector of feature weights <wi,1, wi,2, . . . , wi,j, . . . , wi,m>. Web site vector generator 422 may generate web site vectors included in web site vectors 408 based on an aggregation of document vectors. For example, SITES={s1, s2, . . . , sN} may be a set of “N” web sites of interest, and the documents of D may be the collection of all documents in SITES, where sk⊂D for k=1, . . . , N. SITES is the set of web sites designated for grouping. The vector representation of a web site sk over a generic feature space F is sk=<ck,1, ck,2, . . . , ck,j, . . . , ck,m>, where each weight ck,j corresponds to a weight associated to the web site-feature pair (sk,fj) for fjεF. The value of a weight ck,j is the normalized counterpart of wk,j, and may be determined according to various scaling techniques, such as the tf-idf scaling technique, shown as follows:

$$ck , j = ( 0.5 + \frac{0.5 \cdot {w}^{′} k , j}{max fl ∈ F ( {w}^{′} k , l )} ) \times ( - {log}_{2} \frac{nj}{N} ) , \qquad Equation 1$$

where

w′k,j is the sum of the weights of the documents in sk for a give feature fj:

$${w}^{′} k , j = {\sum }_{di ∈ sk} wi , j , \qquad Equation 2$$

max flεF (w′k, l) is the feature with the largest weight in sk, and

nj is the number of sites where fj appears.

Thus, in embodiments, first and second parameters may be specified when representing a web site skεSITES as a vector, including (1) the feature space F over the documents of all sites in SITES, and (2) the weighting scheme for the features over the documents. Upon determining and/or specifying these parameters, web site vector generator 422 may generate representative vectors for web sites as web site vectors 408.

In embodiments, web sites are modeled using feature spaces based on queries that reflect how web sites are perceived by users. To reflect how web sites are perceived by users, the queries that are submitted to search documents are emphasized rather than the contents of the documents. To achieve this, features are extracted from queries registered in search engine query logs (e.g., query log 122 of FIG. 1). All queries, or just successful queries (i.e., queries that resulted in a selection/click of a document in the web sites), may be used. Even though not all queries that produce a click on a document are actually successful, the noise due to errors is reduced by considering the total volume of clicks in the query log for each query/document pair, which may be a large volume.

Query-set mining may be used to discover query-sets, which are sets of query-terms extracted from individual queries. A query (e.g., query 112) may include a set of query-terms submitted by a user to a search engine as a search string. Query-set mining preserves information provided by the co-occurrence of terms inside queries. Query-set mining may be performed by general itemset mining techniques, in which every query-term is considered as an item and every query occurrence is considered as a transaction. Using such techniques, query-sets are discovered by analyzing all of the queries from which a document was selected to obtain groups of terms that are used together to reach the document.

For example, L may represent a search engine query log and Q may represent a set of distinct queries registered in L. Each query qεQ that resulted in a request (search results) can be repeated one or more times in query log L. For a document d, Q(d) represents a set of distinct queries in Q that each resulted in a request for document d, and L(d) represents the portion of query log L that contains user selection/clicks to document d. Further, QT(d) represents a set of query-terms used in queries Q(d). The following mining tasks may be performed:

Extraction of frequent query-sets: In an embodiment, document vector generator 420 may extract one or more frequent query-sets from query log L. A frequent query-set includes one or more query-terms, is included in one or more queries, and occurs more frequently than a predetermined threshold number of occurrences (τ). For instance, for a document d, the inputs are queries Q(d) and query-terms QT(d). Document vector generator 420 may generate an output set of all frequent query-sets, subject to a support threshold τ, giving an output of query-sets defined as QS(d, τ) for the document d. For example, the queries of “University of Chile,” “University of Chile College of Medicine,” “University of Chile Santiago,” and “Athletics at University of Chile” may be included in a query log. “University of Chile,” “University,” and “Chile” may each be determined to be a frequent query-set because in case of “University” and “Chile”, the terms occur together in more than a predetermined threshold number of queries (e.g., where τ=3).

Extraction of maximal query-sets: In an embodiment, document vector generator 420 may extract one or more maximal query-sets from the set of queries that describe each document. Each document has its own maximal query-set. A maximal query-set includes one or more query-terms, is included in one or more queries, but their frequent subsets are discarded, giving an output set defined as QSM(d). For example, the queries of “University of Chile,” “University of Chile College of Medicine,” “University of Chile College Santiago,” and “Athletics at University of Chile” may lead to a particular resulting document. “University of Chile” may be determined to be a maximal query-set for the document because the terms occur together in the queries. However, although “University” and “Chile” are frequent query-sets, they are subsets of the maximal query-set of “University of Chile,” and thus are discarded.

According to the principles of itemset discovery, the (absolute) support of an itemset x is the number of transactions containing all of the items in x. Similarly, the support of a query-set qs for a document d is the number of queries in query log portion L(d) that contain qs. That is, the support of qs for a document d is the sum of the clicks of each distinct query qεQ(d) such that qs⊂q. The support may be defined as clicks(qs, d). The notation clicks(q, d) may refer to the total number of occurrences of a query q within L(d), i.e., the total number of clicks from query q to document d.

In general, frequent itemset mining enables identification of many itemsets with little support and few itemsets that have high support values. Thus, query-set selection is given a minimum support threshold. However, in embodiments, the distribution of pattern sizes for documents from multiple web sites is quite homogeneous for many or all support thresholds, including web sites that have an opposite distribution of what would normally be expected: few patterns with little support and many patterns with high support. Thus, it may be detrimental to use a minimum threshold to select patterns.

In embodiments, one or more different feature spaces may be defined and used by document vector generator 420 to generate document vectors 424, which are used by web site vector generator 422 to determine web site vectors 408. For example, web sites may be modeled as vectors over a feature space that includes features that are either queries, query-terms, and/or query-sets.

For instance, FIG. 4C shows a block diagram of document vector generator 420, according to an example embodiment. Vector generator 420 of FIG. 4C is configured to generate document vectors with respect to one or more feature sets. As shown in FIG. 4C document vector generator 420 includes a query-term feature space module 430, a full-queries feature space module 432, a full pattern feature space module 434, a maximal patterns feature space module 436, and a full-queries plus feature space module 438. Any one or more of query-term feature space module 430, full-queries feature space module 432, full pattern feature space module 434, maximal patterns feature space module 436, and full-queries plus feature space module 438 may be included in document vector generator 420, in embodiments. Query-term feature space module 430, full-queries feature space module 432, full pattern feature space module 434, maximal patterns feature space module 436, and/or full-queries plus feature space module 438 may be present to enable corresponding feature spaces for determination of document and web site vectors. Query-term feature space module 430, full-queries feature space module 432, full pattern feature space module 434, maximal patterns feature space module 436, and full-queries plus feature space module 438 are each described as follows with respect to their corresponding feature space model.

Query-term feature space module 430 is configured to enable a QUERYTERMS model. According to the QUERYTERMS model, the feature space F includes all individual query-terms that constitute the queries leading to documents in the SITES set. In other words, according to the QUERYTERMS model, the feature space F may be defined as

F=∪_{sεSITES}(∪_{dεs}QT(d)).

Full-queries feature space module 432 is configured to enable a FULLQUERIES model. According to the FULLQUERIES model, the feature space F includes complete queries, namely the queries used to access the documents in the SITES set. In other words, according to the FULLTERMS model, the feature space F may be defined as

F=∪_{sεSITES}(∪_{dεs}Q(d)).

Full pattern feature space module 434 is configured to enable a FULLPATTERNS model. According to the FULLPATTERNS model, the feature space F includes all query-set elements for all documents in the SITES set (i.e., the support threshold τ is zero). In other words, according to the FULLPATTERNS model, the feature space F may be defined as

F=∪_{sεSITES}(∪_{dεs}QS(d,0)).

Maximal patterns feature space module 436 is configured to enable a MAXPATTERNS model. According to the MAXPATTERNS model, the feature space F consists of all maximal query-sets for the documents in the SITES set (i.e., the frequency/support threshold τ is zero). In other words, according to the MAXPATTERNS model, the feature space F may be defined as

F=∪_{sεSITES}(∪_{dεs}QS(d,0)), where the query-sets QS are maximal.

Full-queries plus feature space module 438 is configured to enable a FULLQUERIESPLUS model. According to the FULLQUERIESPLUS model, the feature space F contains for each document d the query-sets for which there is a query in Q (not necessarily in Q(d)), independently of whether the query resulted in a request for document d. In other words, according to the FULLQUERIESPLUS model, the feature space F may be defined as

F=∪_{sεSITES}(∪_{dεs}(QS(d,0)∩Q)).

That is, the FULLQUERIESPLUS model retains query-sets that actually represent a query formulated by a user in order to model documents from a users' point of view.

In embodiments, the weights of the features of individual documents are also considered when generating a vector representative of a web site over the feature spaces. For example, fj may be a feature, such as a query-term, a query-set or a complete query, depending on the utilized feature space. The weight of fj for a document dεD may be determined to be (a) the number of queries in L(d) that contain feature fj, in the case that fj is a query-term or query-set, or may be determined to be (b) the number of queries in L(d) that match exactly fj, in the case that fj is a query. In other words, in an embodiment, the weight of each fj for a document d may be clicks(fj, d), as defined herein. The un-normalized weight of feature fj for the site skεSITES is the sum shown below

$${w}^{′} k , j = {\sum }_{d ∈ sk} clicks ( fj , d ) . \qquad Equation 3$$

The normalized weight ck,j can be calculated according to Equation 1 above.

As such, for each type of feature space, weights (normalized or un-normalized) may be calculated for each feature of feature space F for each document d of documents D (documents 306) to generate a document vector for each of document d (document vectors 424). Query-term feature space module 430 may be configured to determine each feature of feature space F according to the QUERYTERMS model. Full-queries feature space module 432 is configured to determine each feature of feature space F according to the FULLQUERIES model. Full pattern feature space module 434 is configured to determine each feature of feature space F according to the FULLPATTERNS model. Maximal patterns feature space module 436 is configured to determine each feature of feature space F according to the MAXPATTERNS model. Full-queries plus feature space module 438 is configured to determine each feature of feature space F according to the FULLQUERIESPLUS model. After the features are determined for feature space F, document vector generator 420 may determine the weights for each feature of feature space F for each document d of documents D, and use the generated weights to generate document vectors 424.

Note that in an embodiment, when document vector generator 420 is capable of configuring multiple types of feature space, as shown in FIG. 4C, document vector generator 420 may receive a feature space module selector signal 440. Feature space module selector signal 440 may be generated by user interaction with a user interface, in an automated manner, or in other manner. Feature space module selector signal 440 specifies which feature space module is selected/enabled to determine the features for feature space F. For instance, feature space module selector signal 440 may enable one or more of query-term feature space module 430, full-queries feature space module 432, full pattern feature space module 434, maximal patterns feature space module 436, and full-queries plus feature space module 438 to determine the features for the corresponding feature space model.

Thus, in embodiments, web site representation generator 402 is configured to receive documents 306 and determine document vectors 424 by applying a feature space model that defines the feature space, or dimensions, of document vectors 424. As described above, web site vector generator 422 receives document vectors 424, and generates a web site vector for each of the web sites designated for grouping. For example, in an embodiment, web site vector generator 422 may perform a summation (perform a vector sum) of the document vectors of document vectors 424 for the documents that constitute a particular web site to generate a web site vector corresponding to the web site. Each web site vector may be generated in this manner. Web site vector generator 422 generates web site vectors 408, which includes the web site vectors generated for each of the web sites.

As such, in an embodiment, web site representation generator 402 generates a representative web site vector 408 for each web site by applying a feature space model that defines the feature space, or dimensions, of the vectors. In embodiments, the defined feature space includes individual queries, query-terms, query-set elements, maximal query-sets, query-sets that represent an actual query, and/or other query based (non-document content based) features. Thus, web site representation generator 402 may generate different web site vectors for each web site, each vector having a different feature space associated with a specific feature space model.

B. Example Embodiments for Grouping Web Sites

As shown in FIG. 4A, web site grouper 404 receives web site vectors 408. As described above, web site grouper 404 is configured to group the web sites of web site vectors 408, and generates grouping information 310 that indicates the web site groupings (e.g., indicates one or more groups of web sites, and/or further grouping related information). In one embodiment, web site grouper 404 operates on a set of web site vectors generated according to a single feature space model. In other embodiments, web site grouper 404 may be configured to operate on a set of web site vectors generated according to multiple feature space models. Web site grouper 404 may use one or more grouping techniques, including techniques known to persons skilled in the relevant art(s).

“Classification” refers to a supervised procedure, which is a type of procedure that learns to classify new instances based on learning from a training set of instances that have been properly labeled by hand or automatically labeled (e.g., by a software procedure that determines instance labels) with the correct classes. “Clustering” refers to an unsupervised procedure, which is a type of procedure that involves grouping data into clusters or groups based on some measure of inherent similarity (e.g., the distance between instances, considered as vectors in a multi-dimensional vector space). In embodiments, web site grouper 404 may use classification techniques and/or clustering techniques to form groups of web sites according to the received web site vectors.

For instance, FIG. 4D shows a block diagram of web site grouper 404, according to an example embodiment. As shown in FIG. 4D, web site grouper 404 includes a web site classification module 440 and a web site clustering module 442. One or both of web site classification module 440 and web site clustering module 442 may be present in web site grouper 404, in embodiments. Web site classification module 440 is configured to classify the web sites according to web site vectors 408 using a classification model, including any classification model described herein or otherwise known. Web site clustering module 442 is configured to cluster the web sites according to web site vectors 408 using a clustering model, including any clustering model described herein or otherwise known.

Many standard clustering techniques may be applied to web site vectors 408 by web site clustering module 442 to generate grouping information 310, such as the bisecting k-means technique. The bisecting k-means technique includes a k-way clustering solution generated by a sequence of k−1 repeated bisections. For each iteration, a cluster is bisected, optimizing a global clustering criterion function. Subsequent bisections are repeated until a desired number of clusters are obtained. A number of global clustering criterion functions may be employed to select the cluster to bisect during the clustering process. For example, criterion functions presented in “Criterion Functions For Document Clustering: Experiments and Analysis” by Zhao and Karypis in Technical Report, U. Minnesota, Minn., 55455, 2001 (hereinafter “Zhao”), which is incorporated by reference herein in its entirety, may be utilized.

In embodiments, the quality of a utilized clustering solution is assessed using the measures of “entropy” and “purity,” as also described in Zhao. Typically, a good clustering solution maximizes the purity (i.e., shows a high purity value) and minimizes the entropy (i.e., shows a low entropy value). As a result of a clustering technique by web site clustering module 442, grouping information 310 may include one or more web site clusters that include one or more web sites.

Many standard classification techniques may be applied to web site vectors 408 by web site classification module 440 to generate grouping information 310, such as a technique based on logistic regression. The logistic regression model is often successfully applied to many text categorization problems due to the fact that it is scalable to high dimensional data. In embodiments, the classification model is implemented using techniques of logistic regression, such as described in “Trust Region Newton Method For Large-Scale Logistic Regression,” Lin, Weng and Keerthi, JMLR, 9:627-650, 2008, which is incorporated by reference herein in its entirety.

In embodiments, the logistic regression model may be extended using the “one versus rest” (OVR) method, which develops a binary classifier for each category, allowing an objective class to be separated from other classes. Often, OVR techniques exhibit comparable precision performances to actual multi-class methods, reducing training times. As a result of a classification technique performed by web site classification module 440, grouping information 310 may include one or more web site classes that include one or more web sites having web site vectors included in web site vectors 408.

Thus, in embodiments, web site grouper 404 is configured to apply clustering and/or classification models to web site vectors 408 generated by web site representation generator 402 in order to generate grouping information 310.

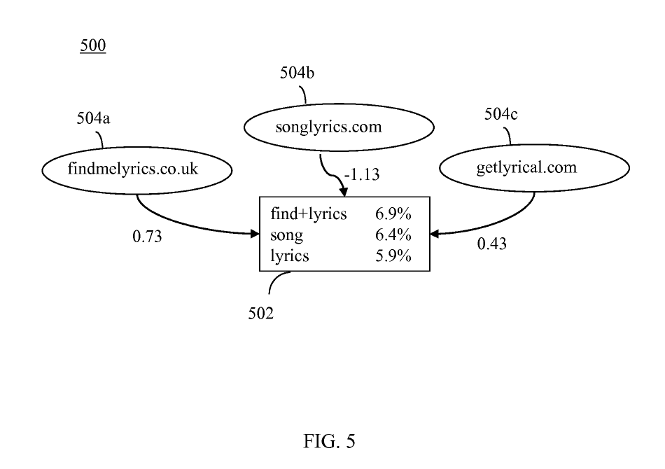

FIG. 5 is a schematic diagram of a cluster 500 that may be generated by web site clustering module 442 of web site grouper 404. Cluster 500 may indicated in grouping information 310, along with further clusters/classifications. For instance, cluster 500 is a cluster generated from web site vectors 408 that were generated from document vectors 424 generated based on the FULLPATTERNS feature space model. Cluster 500 includes descriptive keywords 502 and three web sites 504a, 504b, 504c, grouped in cluster 500. Each of web sites 504a-504c has an edge labeled by the score that the web site achieved in cluster 500 (higher values represent closer semantic relationships). The score for an edge indicates the semantic closeness of the corresponding web site 504 to the descriptive keywords. Cluster 500 and measures (e.g., scores) associated with cluster 500 may optionally be compared to those of other clusters based on various techniques, as described below.

C. Example Embodiments for Comparing Grouping Results

Result comparator 406 shown in FIG. 4A is optional. Result comparator 406, when present, is configured to compare grouping information 310 generated for different feature space models to each other, and/or to grouping information generated according to other techniques, to generate comparison results 410. In embodiments, grouping information 310 is compared with performance results based on a baseline web site model, such as the standard “bag-of-words” model. Both internal quality measures and external measures may be compared to a standard, such the DMOZ directory. In embodiments, clustering solutions may be performed many times (i.e., hundreds of times), with the average of the obtained results being used in the comparisons.

For instance, result comparator 406 may compare the grouping of web sites based on one or more feature space models to a predetermined classification, such as the DMOZ web site classification, to identify a difference between a first classification of the web site and the predetermined classification of the web site. The following experiments provide example results of comparisons between the query-based web site models described herein and standard text-based models.

A data source of a sample of the Yahoo! UK query log, having 2,109,198 distinct queries, 3,991,719 query instances, and 239,274 distinct query-terms, is selected. The models are based on usage data, or data associated with clicked documents, and, the experiments only utilize URLs and web sites that are registered in the query log. Further, the URLs are restricted to URLs that have been clicked at least two times, belong to a web site that is listed in only one DMOZ category, belong to a web site that has at least three other URLs in the dataset, and belong to a DMOZ category that contains URLs (in the dataset) that belong to at least three other web sites. The restriction is applied to ensure that there is enough usage information to model and cluster web sites without introducing click-noise or other noise. Thus, the experiment considered 977 web sites containing 5,070 URLs, classified into 216 DMOZ categories.

Table 1 shows the number of features obtained for each model in the dataset:

TABLE 1

| | | Not |
|---|---|---|
| Model | Number of Features | Null Entries |
| FULLPATTERNS | 56,929 | 72,981 |
| FULLQUERIES | 9,151 | 9,875 |
| FULLQUERIESPLUS | 8,957 | 12,269 |
| MAXPATTERNS | 10,518 | 11,098 |
| QUERYTERMS | 6,763 | 19,096 |
| TEXT (bag-of-words | 178,449 | 591,004 |
| model) | | |

As Table 1 shows, the models based on query-sets significantly reduce the dimensionality of the original feature space obtained using the conventional vector model. Further, some models reduce the dimensionality to a lesser scale than they reduce the number of not null entries. For example, the FULLPATTERNS model reduces the dimensionality by approximately ⅓ of the original feature space, increasing the number of not null entries with respect to QUERYTERMS by approximately 400%.

Different clustering solutions are applied to the models in Table 1, and compared to an external cluster quality indicator, the DMOZ categories, which may be considered the real categories of the web sites. The quality of each clustering solution is measured using the solution's entropy and purity. The methodology used for the evaluation is as follows: For each web site model: generate the model representation for all the sites in the datasets, label each of the web site representations with the DMOZ category in which it belongs, cluster the web sites into as many clusters as DMOZ categories exist in the dataset, and obtain the entropy and purity measures of the solution. The experiment considers the I₁, I₂, H₁, and H₂ global clustering functions, described in Zhao, for the purposes of evaluation.

The results of external measures show that when the number of clusters increases, the performance measured by the purity function increases, and when the number of clusters increases, the entropy of the clustering solution decreases.

The results of internal measures, in which the best clustering solutions are those that maximize the internal similarity and minimize the external similarity, show that the performance of the clustering solution increases when the number of clusters increases, and that methods based on query-sets outperform the baseline method, with the FULLQUERIESPLUS model showing the highest performance measures. Thus, in embodiments, the FULLQUERIESPLUS model enables clusters in which elements are more similar to one another than clusters generated by conventional models, such as the TEXT model. The results also show the FULLPATTERNS model leads to the clustering solution with the best discriminative capacity.

Overall the results obtained according to these measures indicate that the TEXT model, which is the “bag-of-words” model, provides low results when compared to the query-based models, in particular the FULLQUERIESPLUS and FULLPATTERNS models.

The performance of each web site representation in a categorization or classification process is also measured. Classification models based on logistic regression that predict a DMOZ category for new testing instances were built for every web site model. In evaluating the performance of the models, the nominal class and the predicted class are compared for each testing instance, the accuracy measure for the tuning and training process is calculated, and the precision measure is calculated. The overall score is calculated by measuring the average. As an example, the results show the FULLPATTERNS model outperforming the TEXT model by approximately 10%, when we consider the full directory.

In sum, although the clustering and classification experiments show that the TEXT model obtains the best values for purity and entropy, mainly due to the huge, often unmanageable feature space. With respect to internal and external similarity performance functions, the best performing models were the FULLQUERIESPLUS model and FULLPATTERNS model, respectively. For instance, the FULLQUERIESPLUS model identifies more compact clusters, while the FULLPATTERNS model displays the best discriminative capabilities, shown by the classification results. Thus, the performance results of the query-based feature space models provide an advantageous trade-off between the number of features and information. For instance, the FULLPATTERNS model reduces dimensionality in comparison with the TEXT model, but keeps relevant discriminative information, and the FULLQUERIESPLUS model reduces the feature space to a greater degree, although may lose some discriminative features in the process. For example, the models sustain a reduction in the feature space to 5% of the size of the bag-of-words model, while achieving great precision in classification.

D. Example Process Embodiments for Representing and Grouping Web Sites

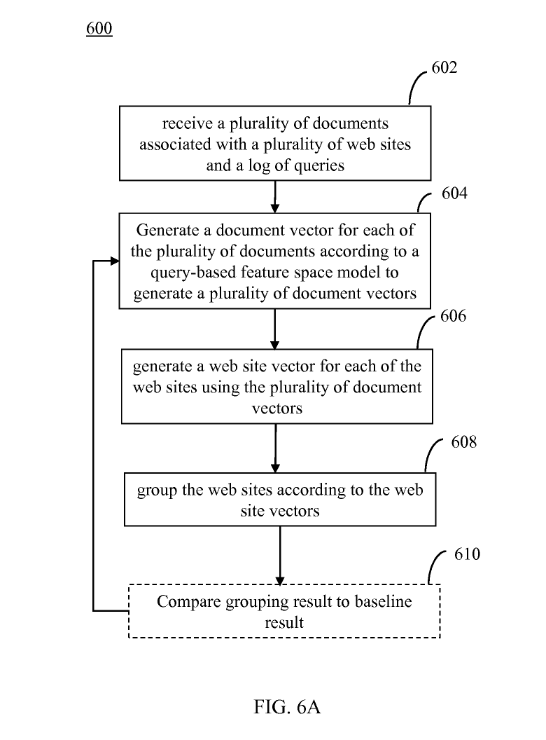

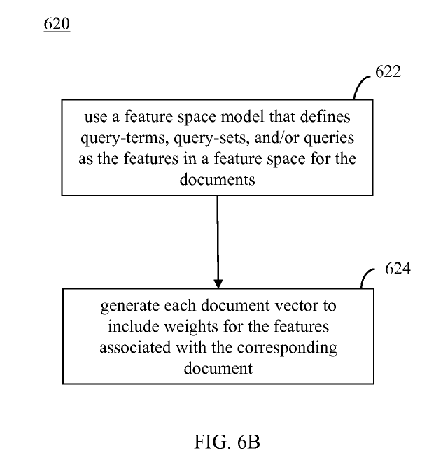

As described above, web site classification system 400 of FIG. 4A may receive documents and related query log information, and may group web sites by utilizing various query-based modeling techniques. For instance, web site classification system 400 may operate according to FIG. 6A. FIG. 6A shows a flowchart 600 for grouping web sites, according to an example embodiment. Flowchart 600 is described as follows with respect to FIGS. 4A-4D for illustrative purposes. Further structural and operational embodiments will be apparent to persons skilled in the relevant art(s) based on the following description of flowchart 600.

Flowchart 600 begins with step 602. In step 602, a plurality of documents associated with a plurality of web sites and a log of queries are received. For instance, as shown in FIG. 4A, web site representation generator 402 receives documents 306 and query information 308. Documents 306 include a plurality of documents, and query information 308 may include a query log storing information associated with queries directed to documents 306.

In step 604, a document vector is generated for each of the plurality of documents according to a query-based feature space model to generate a plurality of document vectors. For instance, as shown in FIG. 4B, document vector generator 420 may generate a document vector for each of documents 306 to generate document vectors 424. In embodiments, document vector generator 420 may generate one or more query-based feature space models to generate document vectors 424.

For instance, in embodiments, document vector generator 420 may perform a flowchart 620 shown in FIG. 6B to generate document vectors 424 according to step 604. In step 622 of flowchart 620, a feature space model is used that defines query-terms, query-sets, and/or queries as the features in a feature space for the documents. For example, as described above, modules 430-438 shown in FIG. 4C may be used to define features according to a query-term model, a full-queries model, a full patterns model, a maximal patterns model, and a full-queries plus model.

In step 624 of flowchart 620, each document vector is generated to include weights for the features associated with the corresponding document. For example, document vector generator 420 may generate a document vector for each document of documents 306 that includes weights for the features of the document defined according to the feature space model being used.

For instance, query-term feature space module 430 may define individual query-terms of the queries as the features. Document vector generator 420 may generate each document vector to include a weight for each query-term included in at least one query that resulted in the corresponding document being selected.

In another embodiment, full-queries feature space module 432 may define the queries as the features. Document vector generator 420 may generate each document vector to include a weight for each query that resulted in the corresponding document being selected.

In another embodiment, full pattern feature space module 434 may define sets of query-terms in queries as the features. Document vector generator 420 may generate each document vector to include a weight for each set of query-terms that was included in a query that resulted in the corresponding document being selected.

In another embodiment, maximal patterns feature space module 436 may define maximal length sets of query-terms in queries as the features (“maximal query-sets”). Document vector generator 420 may generate each document vector to include a weight for each maximal length set of query-terms that was included in a query that resulted in the corresponding document being selected.

In still another embodiment, full-queries plus feature space module 438 may define sets of query-terms that match full-queries in the log of queries as the features. Document vector generator 420 may generate each document vector to include a weight for each set of query-terms matching a full query in the log of queries that resulted in the corresponding document being selected.

Referring back to FIG. 6, in step 606, a web site vector for each of the web sites using the plurality of document vectors is generated. For instance, web site vector generator 422 generates web site vectors 408 based on document vectors 424.

In step 608, the web sites are grouped according to the web site vectors. For instance, web site grouper 404 receives web site vectors 408, and applies a grouping technique to generate grouping information 310 that includes groups of the web sites of web site vectors 408. For instance, web site classification module 440 may use a classification technique to group the web sites. In another embodiment, web site clustering module 442 may use a clustering technique to group the web sites.

In step 610, the grouping result is compared to a baseline result. Step 610 is optional. For instance, result comparator 406 may compares grouping information 310 generated for various query-based feature models, and/or to clusters generated from a standard web site model, and may determine which clusters provides better results. Result comparator 406 outputs comparison results 410.

### III. Example Computer Implementations

Search engine 106, advertisement selector 116, search system 120, search system 302, web site classification system 304, web site classification system 400, web site representation generator 402, web site grouper 404, result comparator 406, document vector generator 420, web site vector generator 422, query-term feature space module 430, full-queries feature space module 432, full pattern feature space module 434, maximal patterns feature space module 436, full-queries plus feature space module 438, web site classification module 440, and web site clustering module 442 may be implemented in hardware, software, firmware, or any combination thereof. For example, search engine 106, advertisement selector 116, search system 120, search system 302, web site classification system 304, web site classification system 400, web site representation generator 402, web site grouper 404, result comparator 406, document vector generator 420, web site vector generator 422, query-term feature space module 430, full-queries feature space module 432, full pattern feature space module 434, maximal patterns feature space module 436, full-queries plus feature space module 438, web site classification module 440, and/or web site clustering module 442 may be implemented as computer program code configured to be executed in one or more processors. Alternatively, search engine 106, advertisement selector 116, search system 120, search system 302, web site classification system 304, web site classification system 400, web site representation generator 402, web site grouper 404, result comparator 406, document vector generator 420, web site vector generator 422, query-term feature space module 430, full-queries feature space module 432, full pattern feature space module 434, maximal patterns feature space module 436, full-queries plus feature space module 438, web site classification module 440, and/or web site clustering module 442 may be implemented as hardware logic/electrical circuitry.

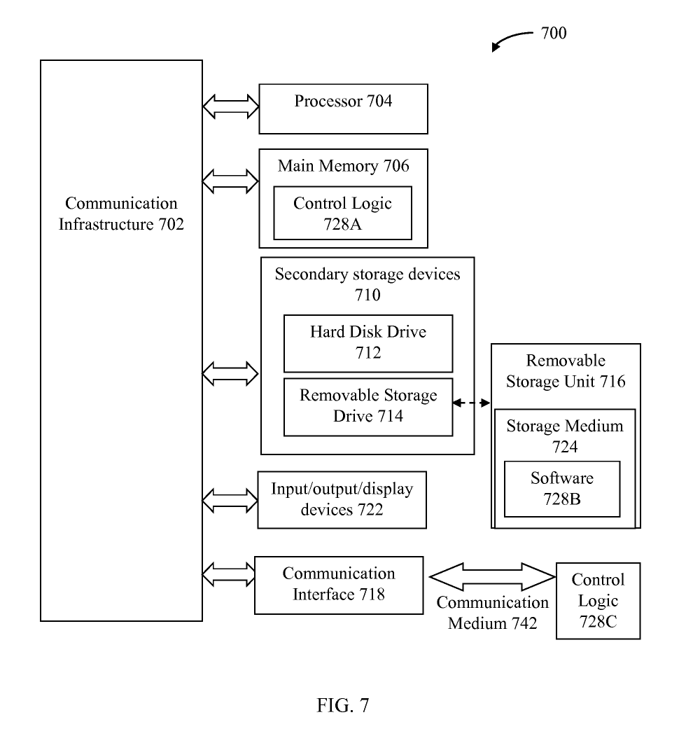

The embodiments described herein, including systems, methods/processes, and/or apparatuses, may be implemented using well known servers/computers, such as a computer 700 shown in FIG. 7. For example, computers 104, search engine 106, advertisement selector 116, search system 120, search system 302, etc., can be implemented using one or more computers 700.

Computer 700 can be any commercially available and well known computer capable of performing the functions described herein, such as computers available from International Business Machines, Apple, Sun, HP, Dell, Cray, etc. Computer 700 may be any type of computer, including a desktop computer, a server, etc.

Computer 700 includes one or more processors (also called central processing units, or CPUs), such as a processor 704. Processor 704 is connected to a communication infrastructure 702, such as a communication bus. In some embodiments, processor 704 can simultaneously operate multiple computing threads.

Computer 700 also includes a primary or main memory 706, such as random access memory (RAM). Main memory 706 has stored therein control logic 728A (computer software), and data.

Computer 700 also includes one or more secondary storage devices 710. Secondary storage devices 710 include, for example, a hard disk drive 712 and/or a removable storage device or drive 714, as well as other types of storage devices, such as memory cards and memory sticks. For instance, computer 700 may include an industry standard interface, such a universal serial bus (USB) interface for interfacing with devices such as a memory stick. Removable storage drive 714 represents a floppy disk drive, a magnetic tape drive, a compact disk drive, an optical storage device, tape backup, etc.

Removable storage drive 714 interacts with a removable storage unit 716. Removable storage unit 716 includes a computer useable or readable storage medium 724 having stored therein computer software 728B (control logic) and/or data. Removable storage unit 716 represents a floppy disk, magnetic tape, compact disk, DVD, optical storage disk, or any other computer data storage device. Removable storage drive 714 reads from and/or writes to removable storage unit 716 in a well known manner.

Computer 700 also includes input/output/display devices 722, such as monitors, keyboards, pointing devices, etc.

Computer 700 further includes a communication or network interface 718. Communication interface 718 enables the computer 1700 to communicate with remote devices. For example, communication interface 718 allows computer 700 to communicate over communication networks or mediums 742 (representing a form of a computer useable or readable medium), such as LANs, WANs, the Internet, etc. Network interface 718 may interface with remote sites or networks via wired or wireless connections.

Control logic 728C may be transmitted to and from computer 700 via the communication medium 742.

Any apparatus or manufacture comprising a computer useable or readable medium having control logic (software) stored therein is referred to herein as a computer program product or program storage device. This includes, but is not limited to, computer 700, main memory 706, secondary storage devices 710, and removable storage unit 716. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for search engine 106, advertisement selector 116, search system 120, search system 302, web site classification system 304, web site classification system 400, web site representation generator 402, web site grouper 404, result comparator 406, document vector generator 420, web site vector generator 422, query-term feature space module 430, full-queries feature space module 432, full pattern feature space module 434, maximal patterns feature space module 436, full-queries plus feature space module 438, web site classification module 440, web site clustering module 442, flowchart 600, flowchart 620 (including any one or more steps of flowcharts 600 and 620), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### VI. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for grouping web sites, comprising:
receiving a plurality of documents associated with a plurality of web sites and a log of queries to the plurality of documents;
generating a document vector for each of the plurality of documents according to a query-based feature space model to generate a plurality of document vectors, the query-based feature space model defining features of the documents, each document vector including weights determined for features associated with the corresponding document;
generating a web site vector for each of the web sites using the plurality of document vectors; and
grouping the web sites according to the web site vectors.

2. The method of claim 1, wherein said generating a document vector for each of the plurality of documents according to a query-based feature space model to generate a plurality of document vectors comprises:
using a query-terms feature space model that defines individual query-terms of the queries as the features; and
generating each document vector to include a weight for each query-term included in at least one query that resulted in the corresponding document being selected.

3. The method of claim 1, wherein said generating a document vector for each of the plurality of documents according to a query-based feature space model to generate a plurality of document vectors comprises:
using a full-queries feature space model that defines the queries as the features; and
generating each document vector to include a weight for each query that resulted in the corresponding document being selected.

4. The method of claim 1, wherein said generating a document vector for each of the plurality of documents according to a query-based feature space model to generate a plurality of document vectors comprises:
using a full patterns feature space model that defines sets of query-terms in queries as the features; and
generating each document vector to include a weight for each set of query-terms that was included in a query that resulted in the corresponding document being selected.

5. The method of claim 1, wherein said generating a document vector for each of the plurality of documents according to a query-based feature space model to generate a plurality of document vectors comprises:
using a maximal patterns feature space model that defines maximal length sets of query-terms in queries as the features; and
generating each document vector to include a weight for each maximal length set of query-terms that was included in a query that resulted in the corresponding document being selected.

6. The method of claim 1, wherein said generating a document vector for each of the plurality of documents according to a query-based feature space model to generate a plurality of document vectors comprises:
using a full-queries plus feature space model that defines sets of query-terms that match full-queries in the log of queries as the features; and
generating each document vector to include a weight for each set of query-terms matching a full query in the log of queries that resulted in the corresponding document being selected.

7. The method of claim 1, wherein said generating a web site vector for each of the web sites using the plurality of document vectors comprises:
combining document vectors of the generated plurality of document vectors for documents that constitute a web site to generate the web site vector corresponding to the web site.

8. The method of claim 1, wherein said grouping the web sites according to the web site vectors comprises:
classifying the web sites with a classification technique.

9. The method of claim 1, wherein said grouping the web sites according to the web site vectors comprises:
clustering the web sites with a clustering technique.

10. A system for enabling web sites to be grouped, comprising:
a document vector generator that receives a plurality of documents associated with a plurality of web sites and a log of queries to the plurality of documents, wherein the document vector generator generates a document vector for each of the plurality of documents according to a query-based feature space model to generate a plurality of document vectors, the query-based feature space model defining features of the documents, each document vector including weights determined for features associated with the corresponding document;
a web site vector generator that generates a web site vector for each of the web sites using the plurality of document vectors; and
a web site grouper that groups the web sites according to the web site vectors.

11. The system of claim 10, wherein the document vector generator defines individual query-terms of the queries as the features, the document vector generator being configured to generate each document vector to include a weight for each query-term included in at least one query that resulted in the corresponding document being selected.

12. The system of claim 10, wherein the document vector generator defines the queries as the features, the document vector generator being configured to generate each document vector to include a weight for each query that resulted in the corresponding document being selected.

13. The system of claim 10, wherein the document vector generator defines sets of query-terms in queries as the features, the document vector generator being configured to generate each document vector to include a weight for each set of query-terms that was included in a query that resulted in the corresponding document being selected.

14. The system of claim 10, wherein the document vector generator defines maximal length sets of query-terms in queries as the features, the document vector generator being configured to generate each document vector to include a weight for each maximal length set of query-terms that was included in a query that resulted in the corresponding document being selected.

15. The system of claim 10, wherein the document vector generator defines sets of query-terms that match full-queries in the log of queries as the features, the document vector generator being configured to generate each document vector to include a weight for each set of query-terms matching a full query in the log of queries that resulted in the corresponding document being selected.

16. The system of claim 10, wherein the web site vector generator combines document vectors of the generated plurality of document vectors for documents that constitute a web site to generate the web site vector corresponding to the web site.

17. The system of claim 10, wherein the web site grouper comprises:
a web site classification module that is configured to classify the web sites according to the web site vectors.

18. The system of claim 10, wherein the web site grouper comprises:
a web site clustering module that is configured to cluster the web sites according to the web site vectors.

19. A computer program product comprising a computer-readable medium having computer program logic recorded thereon for enabling web sites to be grouped, the computer program logic comprising:
receiving a plurality of documents associated with a plurality of web sites and a log of queries to the plurality of documents;
first means for enabling a processor to generate a document vector for each document of a plurality of documents according to a query-based feature space model to generate a plurality of document vectors, the plurality of documents being associated with a plurality of web sites, the query-based feature space model defining features of the documents, each document vector including weights determined for features associated with the corresponding document;
second means for enabling a processor to generate a web site vector for each of the web sites using the plurality of document vectors; and
third means for enabling a processor to group the web sites according to the web site vectors.
